(19) United States
(12) Patent Application Publication
(10) Pub. No.: US 2025/0110791 A1
(43) Pub. Date: Apr. 3, 2025

(54) SYSTEMS AND METHODS FOR APPLYING A COMPLEX DATA PROCESSOR AND ROUTER BY IMPLEMENTING DYNAMIC CONFIGURATION SETTINGS

(71) Applicant: Fidelity Information Services, LLC, Jacksonville, FL (US)

(72) Inventors: Ranadhir GHOSH, St Johns, FL (US); John PLATAIS, Menomonee Falls, WI (US); Ross P. ELLISON, West Windsor, NJ (US)

(21) Appl. No.: 18/962,606

(22) Filed: Nov. 27, 2024

Related U.S. Application Data
(63) Continuation-in-part of application No. 18/478,106, filed on Sep. 29, 2023.

(51) Int. Cl. G06F 9/50

(52) U.S. Cl. CPC G06F 9/5027

(57) ABSTRACT

Computer implemented system and method for routing and processing real-time information event technology data. The method including: receiving a configuration file associated with an external data source; extracting a stream of data from the external data source, the stream of data including one or more data objects, wherein each of the one or more data objects includes a plurality of fields; applying, through a processing platform, a transformation to the one or more data objects, wherein applying the transformation includes applying the transformation to a first field of the plurality of fields for each of the one or more data objects; and routing the one or more data objects to a separate application, storage system, or processing analytics data sink based on the configuration file

### CROSS-REFERENCE TO RELATED APPLICATION(S)

This patent application is a continuation-in-part of and claims the benefit of priority to U.S. application Ser. No. 18/478,106, filed on Sep. 29, 2023, the entirety of which is incorporated herein by reference.

### TECHNICAL FIELD

Various embodiments of the present disclosure relate generally to information technology (IT) management systems and, more particularly, to systems and methods for a complex data processor and router using dynamic configuration settings.

### BACKGROUND

In computing systems, for example computing systems that perform financial services and electronic payment transactions, programing changes may occur. For example, software may be updated. Changes in the system may lead to, defects, issues, bugs or problems (collectively referred to as incidents) within the system. These incidents may occur at the time of a software change or at a later time. These incidents may be costly for the company, as users may not be able to use the services, and due to resources expended by the company to resolve the incidents.

These incidents in the system may need to be examined and resolved in order to have the software services perform correctly. Time may be spent by, for example, incident resolution teams, determining what issues arose within the software services. The faster an incident may be resolved, the less potential costs a company may incur. Thus, promptly identifying and fixing such incidents (e.g., writing new code or updating deployed code) may be important to a company.

Conventional data processing systems may for example struggle to process data in real-time as information technology events occur and data is received. The present disclosure is directed to addressing this and other drawbacks to the existing computing system incident analysis.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate to a method for routing and processing real-time information event technology data, the method including: receiving a configuration file associated with an external data source; extracting a stream of data from the external data source, the stream of data including one or more data objects, wherein each of the one or more data objects includes a plurality of fields; applying, through a processing platform, a transformation to the one or more data objects, wherein applying the transformation includes applying the transformation to a first field of the plurality of fields for each of the one or more data objects; and routing the one or more data objects to a separate application, storage system, or processing analytics data sink based on the configuration file.

In some aspects, the techniques described herein relate to a method, wherein the configuration file includes commands for each of the plurality of fields of the one or more data objects, wherein each of the plurality of fields corresponds to a particular piece of metadata associated with the one or more data objects.

In some aspects, the techniques described herein relate to a method, wherein the configuration file determines whether each field in the plurality of fields has a particular transformation applied and which of the plurality of fields do not need a transformation applied before the routing of the one or more data objects.

In some aspects, the techniques described herein relate to a method, further including: ingesting the one or more data objects, wherein ingesting the one or more data objects includes assigning a timestamp field and a field indicating the association of the external data source to each of the one or more data objects.

In some aspects, the techniques described herein relate to a method, wherein the applying the transformation to the one or more data objects takes place within a tenth of a second of ingesting the one or more data objects.

In some aspects, the techniques described herein relate to a method, wherein the processing platform includes a local repository of an intelligence layer of a machine learning algorithm, the method further including: applying a second transformation with the intelligence layer to a second field of the plurality of fields for each of the one or more data objects based on the configuration file.

In some aspects, the techniques described herein relate to a method, wherein the processing platform does not interact with any outsider servers while applying the intelligence layer.

In some aspects, the techniques described herein relate to a method, wherein, the applying the transformation to the one or more data objects includes: reading the configuration file; based on settings of the configuration file, identifying whether to perform a respective transformation for each field of the plurality of fields for each of the one or more data objects; based on settings of the configuration file, determining what type of respective transformation to apply to the identified fields for each of the one or more data objects; and applying the determined respective transformation to each of the identified fields for each of the one or more data objects.

In some aspects, the techniques described herein relate to a method, further including: upon routing the one or more data objects, applying a batch level processing to one or more fields of the plurality of fields for the one or more data object, wherein the one or more fields did not have a transformation applied by the processing platform.

In some aspects, the techniques described herein relate to a system for routing and processing real-time information event technology data, the system including: a memory having processor-readable instructions stored therein; and at least one processor configured to access the memory and execute the processor-readable instructions to perform operations including: receiving a configuration file associated with an external data source; extracting a stream of data from the external data source, the stream of data including one or more data objects, wherein each of the one or more data objects includes a plurality of fields; applying, through a processing platform, a transformation to the one or more data objects, wherein applying the transformation includes applying the transformation to a first field of the plurality of fields for each of the one or more data objects; and routing the one or more data objects to a separate application, storage system, or processing analytics data sink based on the configuration file.

In some aspects, the techniques described herein relate to a system, wherein the configuration file includes commands for each of the plurality of fields of the one or more data objects, wherein each of the plurality of fields corresponds to a particular piece of metadata associated with the one or more data objects.

In some aspects, the techniques described herein relate to a system, wherein the configuration file determines whether each field in the plurality of fields has a particular transformation applied and which fields of the plurality of fields do not need a transformation applied before the routing of the one or more data objects.

In some aspects, the techniques described herein relate to a system, further including: ingesting the one or more data objects, wherein ingesting the one or more data objects includes assigning a timestamp field and a field indicating the association of the external data source to each of the one or more data objects.

In some aspects, the techniques described herein relate to a system wherein the applying the transformation to the one or more data objects takes place within a tenth of a second of ingesting the one or more data objects.

In some aspects, the techniques described herein relate to a system, wherein the processing platform includes a local repository of an intelligence layer of a machine learning algorithm, the system further including: applying a second transformation with the intelligence layer to a second field of the plurality of fields for each of the one or more data objects based on the configuration file.

In some aspects, the techniques described herein relate to a system, wherein, the applying the transformation to the one or more data objects includes: reading the configuration file; based on settings of the configuration file, identifying whether to perform a respective transformation for each field of the plurality of fields for each of the one or more data objects; based on settings of the configuration file, determining what type of respective transformation to apply to the identified fields for each of the one or more data objects; and applying the determined respective transformation to each of the identified fields for each of the one or more data objects.

In some aspects, the techniques described herein relate to a system further including: upon routing the one or more data objects, applying a batch level processing to one or more fields of the plurality of fields for the one or more data object, wherein the one or more fields did not have a transformation applied by the processing platform.

In some aspects, the techniques described herein relate to a non-transitory computer readable medium configured to store processor-readable instructions which, when executed by at least one processor, cause the at least one processor to perform operations including: receiving a configuration file associated with an external data source; extracting a stream of data from the external data source, the stream of data including one or more data objects, wherein each of the one or more data objects includes a plurality of fields; applying, through a processing platform, a transformation to the one or more data objects, wherein applying the transformation includes applying the transformation to a first field of the plurality of fields for each of the one or more data objects; and routing the one or more data objects to a separate application, storage system, or processing analytics data sink based on the configuration file.

In some aspects, the techniques described herein relate to a non-transitory computer readable medium, wherein the processing platform includes a local repository of an intelligence layer of a machine learning algorithm, further includes: applying a second transformation with the intelligence layer to a second field of the plurality of fields for each of the one or more data objects based on the configuration file.

In some aspects, the techniques described herein relate to a non-transitory computer readable medium, wherein, the applying the transformation to the one or more data objects includes: reading the configuration file; based on settings of the configuration file, identifying whether to perform a respective transformation for each field of the plurality of fields for each of the one or more data objects; based on settings of the configuration file, determining what type of respective transformation to apply to the identified fields for each of the one or more data objects; and applying the determined respective transformation to each of the identified fields for each of the one or more data objects.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1A depicts an exemplary system overview for a data pipeline for an artificial intelligence model to predict and troubleshoot incidents in a system, according to one or more embodiments.

FIG. 1B depicts an exemplary system overview for routing and processing real-time information event technology data, according to one or more embodiments.

FIG. 2 depicts an exemplary flowchart of a process for routing and processing data, according to one or more embodiments.

FIG. 3A depicts an exemplary process flow chart for a conventional data system, according to one or more embodiments.

FIG. 3B depicts an exemplary process flow chart for data processing, according to one or more embodiments.

FIG. 4A depicts an exemplary flowchart of an error causing batch failure in a processing model, according to one or more embodiments.

FIG. 4B depicts an exemplary flowchart of an error occurring within a streamlined processing model, according to one or more embodiments.

FIG. 5 depicts a chart of exemplary transformations in a configuration file, according to one or more embodiments.

FIG. 6 depicts a flowchart of a process for routing and processing real-time information event technology data, according to one or more embodiments.

FIG. 7 illustrates a computer system for executing the techniques described herein, according to one or more embodiments of the present disclosure.

### DETAILED DESCRIPTION OF EMBODIMENTS

Various embodiments of the present disclosure relate generally to information technology (IT) management systems and, more particularly, to systems and methods for a complex data processor and router using dynamic configuration settings.

The subject matter of the present disclosure will now be described more fully with reference to the accompanying drawings that show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter may be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section.

Software companies have been struggling to avoid outages from incidents that may be caused by upgrading software or hardware components, or changing a member of a team, for example. The system described herein may be configured to analyze and/or process event data for an IT system. The system described herein may for example receive a stream of event data over periods of time. This event data may further be described as information technology (IT) event data. Event data may include, but is not limited: (1) an incident, (2) an alert, (3) change data, (4) a problem; and/or (5) an anomaly.

An incident may be an occurrence that can disrupt or cause a loss of operation, services, or functions of a system. Incidents may be manually reported by customers or personnel, may be automatically logged by internal systems, or may be captured in other ways. An incident may occur from factors such as hardware failure, software failure, software bugs, human error, and/or cyber attacks. Deploying, refactoring, or releasing software code may for example cause an incident. An incident may be detected during, for example, an outage or a performance change. An incident may include characteristics (e.g., metadata), where an incident characteristic may refer to the quality or traits associated with an incident. For example, incident characteristics may include, but is not limited to, the severity of an incident, the urgency of an incident, the complexity of an incident, the scope of an incident, the cause of an incident, and/or what configurable item corresponds to the incident (e.g., what systems/platforms/products etc. are affected by the incident), how it is described in freeform text, what business segment is affected, what category/subcategory is affected, and/or what assigned group is affected by the incident.

An alert may refer to a notification that informs a system or user of an event. An alert may include notification of a collection of events representing a deviation from normal behavior for a system. For example, an alert may include metadata including a short field description that includes free from text fields (e.g., a summary of the alert), first occurrences, time stamps, an alert key, etc. Understanding the different types of alerts within a system from various perspectives may assist in resolving incidents.

Change data may refer to information that describes a modification made to data within a system or database. Change data may track the changes that occur over one or more periods of time. Problem data may refer to any data that causes issues or impedes a systems normal operations. Anomaly data may refer to data that indicates a deviation of a system from a standard or normal operation.

The event data may further include entities effected by the event and their respective relationships. Event data may be associated with one or more configurable items (Cis). A configurable item (CI) may refer to a component of a system which can be identified as a self-contained unit for purposes of change control and identification. For example, a particular application, service, particular product, and/or server, may be defined by a CI.

An incident may further be associated with a particular line of business (LOB). The LOB may refer to an assigned category, where the LOB may include association logic linking a LOB with one or more of: business services, service offerings, applications, application instances or web services, and/or servers and services. A LOB may be associated with a variety of CIs.

Processing a vast amount of information, such as IT events, to produce meaningful and actionable insights in IT operations may be valuable to organizations. As IT management systems utilize sophisticated tools and sensors, billions of data points may be received, and information overload may become an issue to be resolved. It may be challenging to analyze and make sense of heterogeneous and asynchronous IT operations event data. The data may for example be complex and difficult to interpret using conventional techniques. Further, data may be received at invariable rates throughout the day. Certain data may further need to be processed at a more expedited rate. For example, major alerts and incidents may need to be reported as soon as possible after received.

Conventional IT data management systems may struggle to process data in real-time. Conventional data pipelines may rely on batch processing to handle large volumes of data, where processing may take place at scheduled times. Batch processing may involve processing data in large groups or “batches” rather than processing each individual data item separately. This method is particularly effective when dealing with vast amounts of data, as it can help optimize computational resources and reduce load times.

The use of batch processing in data pipelines may pose challenges for downstream processes and systems. One of the main issues may be latency. Because batch processing involves collecting a batch of data before processing it, there may often be a delay between the time the data is collected and when it is available for use in downstream processes. All events down the waterfall may also be held by the same batch schedule as the upstream events resulting in an entire data pipeline of batched events. This may be problematic for applications or analysis that require real-time or near-real-time data.

Another issue with batch processing may be the potential impact on system performance. Executing batch data pipelines may put a significant load on the consumed data source, especially when dealing with very large data sets because the system may need to extract all data at once. This can lead to performance issues such as slow response times or system crashes if not properly managed.

Batch processing can also lead to data integrity issues. If an error occurs during the processing of a batch, it can affect all data in that batch, leading to inaccurate results in downstream process. Additionally if the batch processing system is not properly monitored and maintained, it can lead to data quality problems such as missing or duplicate data.

Batch data processing may be dependent on rigid requirements of source data and output data. A single piece of data in the entire batch with an error can cause the entire batch to be lost, and a crash in the program. Changing routing conditions at any step of the data pipeline process may have an incredibly high likelihood of causing at least one of the records in the batch to not behave as expected leading to said losses or crashes.

In summary, while batch processing may be a powerful tool for handling large data volumes in modern data pipelines, its impact on downstream process and systems are handled more efficiently via stream processing.

The systems and methods described herein may involves implementing stream processing to overcome the challenges posed by batch processing in modern data pipelines. Stream processing may be a method that analyzes, filters, transforms, and enhances continuous data streams in real-time as they flow, then sends them to application, storage systems or other stream-processing analytics. The system described herein may implement software such as Pyflink to perform the stream-processing analytics. By implementing stream processing, the techniques described herein may solves the latency issue associated with batch processing by processing data as it enters the system, eliminating any wait time between the collection and processing of data. This may allow for immediate analysis and decision-making, making it ideal for applications that require real-time or near-real-time data.

One or more embodiments may provide real time-processing of IT event data. The stream data processing techniques described herein may allow for real-time analysis which may be a significant improvement over batch processing which can only process data after collecting it over a certain period. The stream processing data techniques may allow for data to be analyzed and acted on as soon as it arrives within a system.

One or more embodiments may provide lower latency. Stream data processing may provide lower latency because stream data does not need to wait for a full batch prior to processing.

One or more embodiments may provide dynamic data routing. The techniques described herein may route data based on predefined conditions (e.g., as defined in a configuration file). This may be an improvement over batch processing which often follows a fixed path and schedule. Dynamic routing may ensure that each data item is processed in most appropriate manner improving efficiency and accuracy.

One or more embodiments may provide improved resource utilization. The stream processing techniques described herein may lead to more efficient resource utilization by processing data as it arrives, reducing periods of high and low demand. One or more embodiments may provide handling data improvements. The stream processing techniques described herein may robustly handle updates to data more efficiently than batch processing, as requirements for data processing may frequently change.

One or more embodiments may have increased fault tolerance. The stream processing techniques described herein may, at worst, only fail on the single piece of data level as opposed to an entire batch. Updating code to fix conditions to handle failures may be significantly easier with the system described herein as contrasted with conventional systems that implement with batch conditions.

One or more embodiments may have increase scalability. The real time data routing and analysis techniques may allow for scaling with data infrastructures as data loads increase over time. One or more embodiments may be extended to clients and users of services and software with applications that are connected to the system described herein.

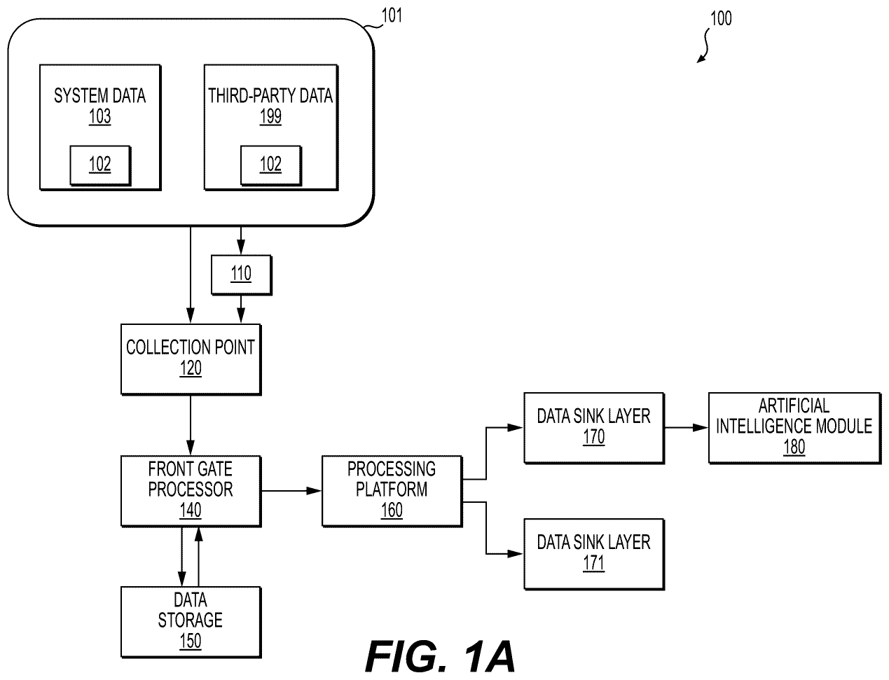

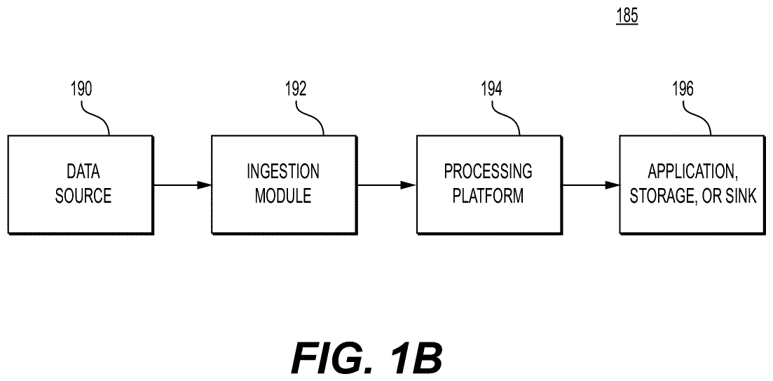

FIG. 1A depicts an exemplary system overview for a data pipeline for an artificial intelligence model to analyze IT data in a system, according to one or more embodiments. For example, the data pipeline system 100, may aggregate and send IT data to a data sink layer 170. The data pipeline system 100 may be a platform with multiple interconnected components. The data pipeline system 100 may include one or more servers, intelligent networking devices, computing devices, components, and corresponding software for aggregating and processing data. The data pipeline system 100 may implement the techniques for streamlining processing of data as described herein.

As shown in FIG. 1A, a data pipeline system 100 may include a data source 101, a collection point 120, a secondary collection point 110, a front gate processor 140, data storage 150, a processing platform 160, the data sink layer 170, a data sink layer 171, and an artificial intelligence module 180.

The data source 101 may include in-house data 103 and third party data 199. The in-house data 103 may be a data source directly linked to the data pipeline system 100. Third party data 199 may be a data source connected to the data pipeline system 100 externally as will be described in greater detail below.

Both the in-house data 103 and third party data 199 of the data source 101 may include incident data 102. Incident data 102 may include incident reports with information for each incident provided with one or more of an incident number, closed date/time, category, close code, close note, long description, short description, root cause, or assignment group. Incident data 102 may include incident reports with information for each incident provided with one or more of an issue key, description, summary, label, issue type, fix version, environment, author, or comments. Incident data 102 may include incident reports with information for each incident provided with one or more of a file name, script name, script type, script description, display identifier, message, committer type, committer link, properties, file changes, or branch information. Incident data 102 may include one or more of real-time data, market data, performance data, historical data, utilization data, infrastructure data, or security data. These are merely examples of information that may be used as data, and the disclosure is not limited to these examples. The data source may further be configured to output IT event data including alert data, change data, problem data, and/or anomaly data with corresponding metadata as described above.

Incident data 102 may be generated automatically by monitoring tools that generate alerts and incident data to provide notification of high-risk actions, failures in IT environment, and may be generated as tickets. Incident data may include metadata, such as, for example, text fields, identifying codes, and time stamps.

The in-house data 103 may be stored in a relational database including an incident table. The incident table may be provided as one or more tables, and may include, for example, one or more of problems, tasks, risk conditions, incidents, or changes. The relational database may be stored in a cloud. The relational database may be connected through encryption to a gateway. The relational database may send and receive periodic updates to and from the cloud. The cloud may be a remote cloud service, a local service, or any combination thereof. The cloud may include a gateway connected to a processing API configured to transfer data to the collection point 120 or a secondary collection point 110. The incident table may include incident data 102.

Data pipeline system 100 may include third party data 199 generated and maintained by third party data producers. Third party data producers may produce incident data 102 from Internet of Things (IoT) devices, desktop-level devices, and sensors. Third party data producers may include but are not limited to Tryambak, Appneta, Oracle, Prognosis, ThousandEyes, Zabbix, ServiceNow, Density, Dyatrace, etc. The incident data 102 may include metadata indicating that the data belongs to a particular client or associated system.

The data pipeline system 100 may include a secondary collection point 110 to collect and pre-process incident data 102 from the data source 101. The secondary collection point 110 may be utilized prior to transferring data to a collection point 120. The secondary collection point 110 point may, for example, be an Apache MiNiFi software. In one example, the secondary collection point 110 may run on a microprocessor for a third party data producer. Each third party data producer may have an instance of the secondary collection point 110 running on a microprocessor. The secondary collection point 110 may support data formats including but not limited to JSON, CSV, Avro, ORC, HTML, XML, and Parquet. The secondary collection point 110 may encrypt incident data 102 collected from the third party data producers. The secondary collection point 110 may encrypt incident data, including, but not limited to, Mutual Authentication Transport Layer Security (mTLS), HTTPs, SSH, PGP, IPsec, and SSL. The secondary collection point 110 may perform initial transformation or processing of incident data 102. The secondary collection point 110 may be configured to collect data from a variety of protocols, have data provenance generated immediately, apply transformations and encryptions on the data, and prioritize data.

The data pipeline system 100 may include a collection point 120. The collection point 120 may be a system configured to provide a secure framework for routing, transforming, and delivering data across from the data source 101 to downstream processing devices (e.g., the front gate processor 140). The collection point 120 may, for example, be a software such as Apache NiFi. The collection point 120 may receive raw data and the data's corresponding fields such as the source name and ingestion time. The collection point 120 may run on a Linux Virtual Machine (VM) on a remote server. The collection point 120 may include one or more nodes. For example, the collection point 120 may receive incident data 102 directly from the data source 101. In another example, the collection point 120 may receive incident data 102 from the secondary collection point 110. The secondary collection point 110 may transfer the incident data 102 to the collection point 120 using, for example, Site-to-Site protocol. The collection point 120 may include a flow algorithm. The flow algorithm may connect different processors, as described herein, to transfer and modify data from one source to another. For each third party data producer, the collection point 120 may have a separate flow algorithm. Each flow algorithm may include a processing group. The processing group may include one or more processors. The one or more processors may, for example, fetch incident data 102 from the relational database. The one or more processors may utilize the processing API of the in-house data 103 to make an API call to a relational database to fetch incident data 102 from the incident table. The one or more processors may further transfer incident data 102 to a destination system such as a front gate processor 140. The collection point 120 may encrypt data through HTTPS, Mutual Authentication Transport Layer Security (mTLS), SSH, PGP, IPsec, and/or SSL, etc. The collection point 120 may support data formats including but not limited to JSON, CSV, Avro, ORC, HTML, XML, and Parquet. The collection point 120 may be configured to write messages to clusters of a front gate processor 140 and communication with the front gate processor 140.

The data pipeline system 100 may include a distributed event streaming platform such as a front gate processor 140. The front gate processor 140 may be connected to and configured to receive data from the collection point 120. The front gate processor 140 may be implemented in an Apache Kafka cluster software system. The front gate processor 140 may include one or more message brokers and corresponding nodes. The message broker may, for example, be an intermediary computer program module that translates a message from the formal messaging protocol of the sender to the formal messaging protocol of the receiver. The message broker may be on a single node in the front gate processor 140. A message broker of the front gate processor 140 may run on a virtual machine (VM) on a remote server. The collection point 120 may send the incident data 102 to one or more of the message brokers of the front gate processor 140. Each message broker may include a topic to store similar categories of incident data 102. A topic may be an ordered log of events. Each topic may include one or more sub-topics. For example, one sub-topic may store incident data 102 relating to network problems and another topic may store incident data 102 related to security breaches from third party data producers. Each topic may further include one or more partitions. The partitions may be a systematic way of breaking the one topic log file into many logs, each of which can be hosted on a separate server. Each partition may be configured to store as much as a byte of incident data 102. Each topic may be partitioned evenly between one or more message brokers to achieve load balancing and scalability. The front gate processor 140 may be configured to categorize the received data into a plurality of client categories, thereby forming a plurality of datasets associated with the respective client categories. These datasets may be stored separately within the storage device as described in greater detail below. The front gate processor 140 may further transfer data to storage and to processors for further processing.

For example, the front gate processor 140 may be configured to assign particular data to a corresponding topic. Alert sources may be assigned to an alert topic, and incident data may be assigned to an incident topic. Change data may be assigned to a change topic. Problem data may be assigned to a problem topic.

The data pipeline system 100 may include a software framework for data storage 150. The data storage 150 may be configured for long term storage and distributed processing. The data storage 150 may be implemented using, for example, Apache Hadoop. The data storage 150 may store incident data 102 transferred from the front gate processor 140. In particular, data storage 150 may be utilized for distributed processing of incident data 102, and Hadoop distributed file system (HDFS) within the data storage may be used for organizing communications and storage of incident data 102. For example, the HDFS may replicate any node from the front gate processor 140. This replication may protect against hardware or software failures of the front gate processor 140. The processing may be performed in parallel on multiple servers simultaneously.

The data storage 150 may include an HDFS that is configured to receive the metadata (e.g., incident data). The data storage 150 may further process the data utilizing a MapReduce algorithm. The MapReduce algorithm may allow for parallel processing of large data sets. The data storage 150 may further aggregate and store the data utilizing Yet Another Resource Negotiation (YARN). YARN may be used for cluster resource management and planning tasks of the stored data. For example, a cluster computing framework, such as the processing platform 160, may be arranged to further utilize the HDFS of the data storage 150. For example, if the data source 101 stops providing data, the processing platform 160 may be configured to retrieve data from the data storage 150 either directly or through the front gate processor 140. The data storage 150 may allow for the distributed processing of large data sets across clusters of computers using programming models. The data storage 150 may include a master node and an HDFS for distributing processing across a plurality of data nodes. The master node may store metadata such as the number of blocks and their locations. The main node may maintain the file system namespace and regulate client access to said files. The main node may comprise files and directories and perform file system executions such as naming, closing, and opening files. The data storage 150 may scale up from a single server to thousands of machines, each offering local computation and storage. The data storage 150 may be configured to store the incident data in an unstructured, semi-structured, or structured form. In one example, the plurality of datasets associated with the respective client categories may be stored separately. The master node may store the metadata such as the separate dataset locations.

The data pipeline system 100 may include a real-time processing framework, e.g., a processing platform 160. In one example, the processing platform 160 may be a distributed dataflow engine that does not have its own storage layer. For example, this may be the software platform Apache Flink. In another example, the software platform Apache Spark may be utilized. The processing platform 160 may support stream processing and batch processing. Stream processing may be a type of data processing that performs continuous, real-time analysis of received data. Batch processing may involve receiving discrete data sets processed in batches. The processing platform 160 may include one or more nodes. The processing platform 160 may aggregate incident data 102 (e.g., incident data 102 that has been processed by the front gate processor 140) received from the front gate processor 140. The processing platform 160 may include one or more operators to transform and process the received data. For example, a single operator may filter the incident data 102 and then connect to another operator to perform further data transformation. The processing platform 160 may process incident data 102 in parallel. A single operator may be on a single node within the processing platform 160. The processing platform 160 may be configured to filter and only send particular processed data to a particular data sink layer. For example, depending on the data source of the incident data 102 (e.g., whether the data is in-house data 103 or third party data 199), the data may be transferred to a separate data sink layer (e.g., the data sink layer 170, or the data sink layer 171). Further, additional data that is not required at downstream modules (e.g., at the artificial intelligence module 180) may be filtered and excluded prior to transferring the data to a data sink layer.

The processing platform 160 may perform three functions. First, the processing platform 160 may perform data validation. The data's value, structure, and/or format may be matched with the schema of the destination (e.g., the data sink layer 170). Second, the processing platform 160 may perform a data transformation. For example, a source field, target field, function, and parameter from the data may be extracted. Based upon the extracted function of the data, a particular transformation may be applied. The transformation may reformat the data for a particular use downstream. A user may be able to select a particular format for downstream use. Third, the processing platform 160 may perform data routing. For example, the processing platform 160 may select the shortest and/or most reliable path to send data to a respective sink layer (e.g., the data sink layer 170 and/or the data sink layer 171).

In one example, the processing platform 160 may be configured to transfer particular sets of data to a data sink layer. For example, the processing platform 160 may receive input variables for a particular artificial intelligence module 180. The processing platform 160 may then filter the data received from the front gate processor 140 and only transfer data related to the input variables of the artificial intelligence module 180 to a data sink layer.

The data pipeline system 100 may include one or more data sink layers (e.g., the data sink layer 170 and the data sink layer 171). Incident data 102 processed from processing platform 160 may be transmitted to and stored in the data sink layer 170. In one example, the data sink layer 171 may be stored externally on a particular client's server. The data sink layer 170 and the data sink layer 171 may be implemented using a software such as, but not limited to, PostgreSQL, HIVE, Kafka, OpenSearch, and Neo4j. The data sink layer 170 may receive in-house data 103, which have been processed and received from the processing platform 160. The data sink layer 171 may receive third party data 199, which have been processed and received from the processing platform 160. The data sink layers may be configured to transfer incident data 102 to an artificial intelligence module 180. The data sink layers may be data lakes, data warehouses, or cloud storage systems. Each data sink layer may be configured to store incident data 102 in both a structured or unstructured format. The data sink layer 170 may store incident data 102 with several different formats. For example, the data sink layer 170 may support data formats such as JavaScript Objection Notation (JSON), comma-separated value (CSV), Avro, Optimized Row Columnar (ORC), Hypertext Markup Language (HTML), Extensible Markup Language (XML), or Parquet, etc. The data sink layer (e.g., the data sink layer 170 or the data sink layer 171), may be accessed by one or more separate components. For example, the data sink layer may be accessed by a Non-structured Query language (“NoSQL”) database management system (e.g., a Cassandra cluster), a graph database management system (e.g., Neo4j cluster), further processing programs (e.g., Kafka+Flink programs), and a relation database management system (e.g., PostgresSQL cluster). Further processing may then be performed prior to the processed data being received by an artificial intelligence module 180.

The data pipeline system 100 may include an artificial intelligence module 180. The artificial intelligence module 180 may include a machine-learning component (e.g., one or more machine learning models). The artificial intelligence module 180 may use the received data in order to train and/or use a machine learning model. The machine learning model may be, for example, a neural network. Nonetheless, it should be noted that other machine learning techniques and frameworks may be used by the artificial intelligence module 180 to perform the methods contemplated by the present disclosure. For example, the systems and methods may be realized using other types of supervised and unsupervised machine learning techniques such as regression problems, random forest, cluster algorithms, principal component analysis (PCA), reinforcement learning, or a combination thereof. The artificial intelligence module 180 may be configured to extract and receive data from the data sink layer 170.

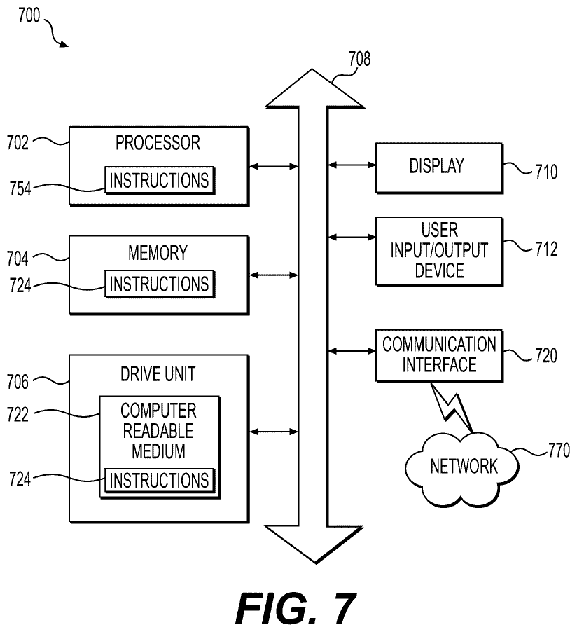

FIG. 1B depicts an exemplary system 185 overview for routing and processing real-time information event technology data, according to one or more embodiments. The system 185 may be implemented by aspects or modules of the data pipeline system 100 from FIG. 1A or by any computing system capable of performing the procedures (e.g., a computer system 700 of FIG. 7). The system 185 may include a data source 190, an ingestion module 192, a processing platform 194, an application, storage, or an application, storage, or data sink 196, as discussed in more detail below.

The data source 190 may be implemented by aspects of data source 101 of FIG. 1A. The data source 190 may, for example, receive and output new IT event data objects and corresponding multivariate data associated with an IT event data object over a period of time. The data source 190 may receive new IT event data objects from multiple different external sources simultaneously. The data source 190 may receive a stream of data objects at various time intervals. The received IT event data objects may include a set of fields, wherein the set of fields includes the multivariate data associated with the data objects. An exemplary IT event data object may include an incident data object. The incident data object may represent the occurrence of an incident within a system. The multivariate information for an IT event data object, such as an incident data object, may include, but is not limited to, one or more of a short description, a business category, a business sub-category, a LOB, and an incident priority. The LOB may be a category, where the LOB may include association logic linking the LOB with one or more of business services, service offerings, applications, application instances or web services, and/or servers and services.

The ingestion module 192 may be configured to extract a stream of data from the data source 190. The ingestion module 192 may be configured to perform a direct query to the data source 190 to retrieve IT event data objects as they are received by the data source 190. The ingestion module 192 may be configured to assign a timestamp and an association to each received IT event data object. These may be recorded as new fields for each of the received IT event data objects.

The processing platform 194 may be implemented by aspects of the processing platform 160 and front gate processor 140. For example, the processing platform 194 may implement Pyflink software. The processing platform 194 may receive the IT event data objects from the ingestion module and apply one or more transformations to the set of fields of each of the one or more data objects. For example, the processing platform 194 may be configured to apply particular transformations to particular fields of received IT event data objects.

The processing platform 194 may further be configured to receive one or more configuration files, where the configuration file includes commands (e.g., particular transformations) for each field in the set of fields for a received data object. A particular configuration file may be received for each external source that the processing platform 194 processes. The configuration file may be in JavaScript Object Notation (JSON) format. The configuration file may further include the priority at which particular data objects and fields of data objects should be transformed. The configuration file may include information on whether each field of a data object needs to be processed immediately (e.g., streamed) or may be processed at a later time (e.g., batch processed). This may be referred to as performing a splitting to split fields of data for a data object into a first category to be processed immediately, referred to as speed layer fields, and a second category to be processed in batch, referred to as batch layer fields. Some speed layer fields may not require a transformation be applied by the processing platform, but rather, that the field be routed to an application, storage, or the application, storage, or data sink 196 quickly. In an example case, for an incident data object, the priority number, short description, and assigned number may all be speed layer fields.

The processing platform 194, analyzing data either immediately (streamed data) or later (data that may be batched), may be referred to as applying lazy processing. Further, the processing platform 194 may incorporate dynamic configuration. This may mean that the system may be configured to be updated to allow certain fields of data objects to be re-prioritized between the fast processing and slow processing layers. This may for example be performed by updating the configuration file.

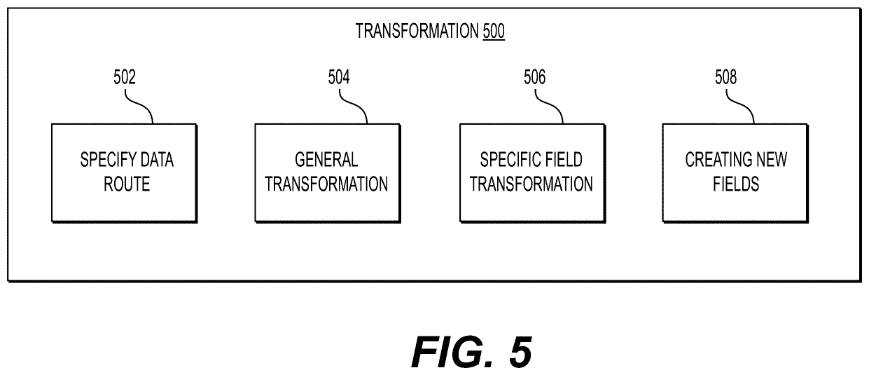

The processing platform 194 may further be configured to apply particular transformations to the fields of the received IT event data objects. Exemplary transformations may further be described in FIG. 5 described below. For example, transformations may specify data's route (for a field of a data object), include general transformations, or apply specific transformations. For example, the configuration file may include transformations such as maps, filter, flat map, or reduce to various fields. The processing platform 194 may further be configured to apply one or more custom transformations by implementing one or more customized intelligence layers as described below.

For example, the processing platform 194 may further include one or more intelligence layers of a machine learning model, which may be received and deployed within the processing platform 194. This may allow for the processing platform 194 to apply one or more transformations, while utilizing one or more machine learning techniques, without accessing an external server through an Application Programming Interface (API) such as a rest.api, flask.api, or graphql. The processing platform 194 may thus include a local repository with one or more machine learning algorithms configured to apply transformation to data. This may allow for customized transformation to be applied quickly to speed layer fields.

The processing platform 194 may be configured to route the fields of the one or more data objects to one or more of the separate application, storage, or data sink 196. The processing platform 194 may read a configuration file to determine where a particular filed should be sent. In some example, different fields of the same data object may be sent to different applications, storages, or data sinks 196. In some examples, particular fields may be routed to more than one other applications, storage, or data sink 196. Within the application, storage, or data sink 196 further processing, analysis, and reporting may proceed. The application may include processing platform 160, the storage may refer to data storage 150, and the data sink may refer to the data sink layer 170 or the data sink layer 171.

In an example, the application, storage, or data sink 196 may include one or more alert systems to provide an alert to an external system or user upon the occurrence of a received field. For example, an incident data object that includes a high priority may be routed to an application that may immediately alert a user that a major incident has occurred for a particular external system. Providing this alert/notification as fast as possible may allow for major incidents to be addresses in a faster timeline.

The system 185 described herein may be able to handle millions of event data per second at the singular piece of data level, performing analysis, enrichment/processing, and routing simultaneously. The system 185 may apply real-time analytic and data routing.

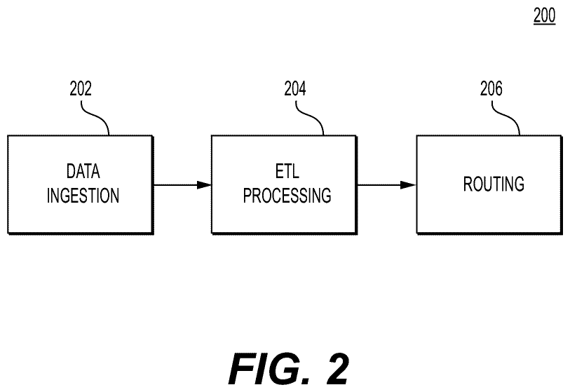

FIG. 2 depicts an exemplary flowchart 200 of a process for routing and processing data, according to one or more embodiments. The method described in FIG. 2 may be implemented by the data pipeline system 100 of FIG. 1A and/or by the system 185 of FIG. 1B.

Prior to the process of FIG. 2 occurring, the system (e.g., the processing platform 194) may receive a configuration file. The configuration file may be associated with a particular external source. The configuration file may include commands for each set of fields of received data objects from the particular external source. The configuration file may be in a JSON format. The configuration file may include information on whether each field of a data object needs to be processed immediately (e.g., streamed) or may be processed later in a batch. This may be referred to as performing a splitting which split fields of a data object into a first category to processed immediately, referred to as speed layer fields, and a second category to be processed in batch, referred to as batch layer fields.

At step 202, the system may ingest (e.g., through the ingestion module 192) a first data object from an external data source (e.g., data source 190), wherein the first data object has a plurality of fields. The plurality of fields may correspond to the metadata associated with the first data object. For example, if the first data object is an incident data object, some of the plurality of fields may correspond to an identification number, a severity of the incident, a freeform text description of the incident, a time that the incident occurred, and whether the incident was major or not. As the system ingests the first data object, a timestamp field indicating a time of ingestion and a field indicating the associated external source may be added to the first data object.

At step 204, the system (e.g., the processing platform) may apply extraction and/or transformation algorithms to the first data object. An extraction algorithm may extract the received data object from the ingestion module 192. Next, one or more transformation algorithms may be applied to the plurality of fields of the first data object. The application of transformation to the plurality of fields may be done based on the configuration file. For example, the system may read the configuration file, and based on settings of the configuration file identify a first set of the plurality of fields to have transformations applied (e.g., be speed processed) and a second set of the plurality of fields to not have transformation applied (e.g., to be routed and potentially batch processed later). The system may further read the configuration file to determine, for the first set of the plurality of fields, which transformations to apply to the respective fields. Exemplary transformations that may be applied include maps, filter, flat map, or reduce functions and the transformations described in FIG. 5 below.

Additionally, as described in FIG. 1B, the processing platform 194 may include a local repository of one or more intelligence layer of a machine learning algorithms. Based on the configuration file, particular fields from the first set may have one or more machine learning algorithms applied to process the fields.

At step 206, the first data object and plurality of fields may be routed, also referred to as loaded, to a separate application, storage, system or processing analytics data sink (e.g., an application, storage, or data sink 196) based on the configuration file. This may include sending different fields to different applications or sinks.

In some applications, data from the second set of fields may be batch processed. This may occur at set intervals of time. In some applications, particular fields from the first set of fields may be forwarded to an alert system.

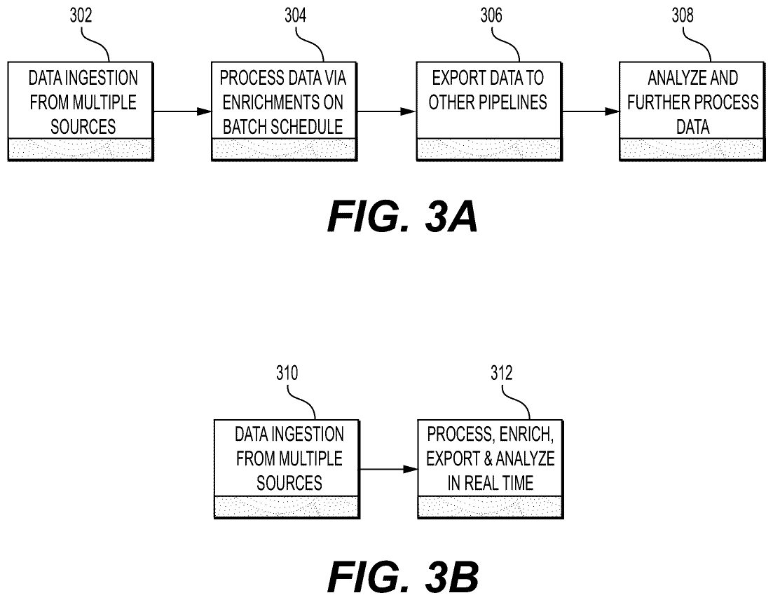

FIG. 3A may depict an exemplary process flow chart for a conventional data system, according to one or more embodiments. The conventional system may rely on batch processing data objects at a time schedule. A flaw in this system is that all events down the waterfall of processing may be held by the same batch schedule based on upstream event.

At step 302, an IT event data object may be ingested from one or more sources. At step 304, data processing techniques may be applied via enrichments on a batch schedule. A batch schedule may refer to a planned sequence of tasks or jobs that are grouped together and processed together at set intervals rather than when they're received. Batch processing may involve processing data in large groups or “batches” rather than processing each individual data item separately. This method may be particularly effective when dealing with vast amounts of data, as it can help optimize computational resources and reduce load times.

At step 306, the processed data from the conventional system may be exported to other modules within a pipeline and/or exported to separate data pipelines. Lastly, at step 308, data may be further processed and analyzed (e.g., by a sink layer).

As discussed above, the use of batch processing in data pipelines may provide challenges for downstream processes and systems. For example, batch processing may lead to latency issues. As batch processing involves collecting a batch of data before processing it, there may often be a delay between the time the data is collected and when it is available for use in downstream processes. This can be problematic for applications or analysis that require real-time or near-real-time data.

Another issues with the conventional system of FIG. 3A is the potential impact on system performance. Executing batch data pipelines may put a significant load on the consumed data source especially when dealing with very large data sets because the systems may need to extract all data at once. This may lead to performance issues such as slow response times or system crashes if not properly managed.

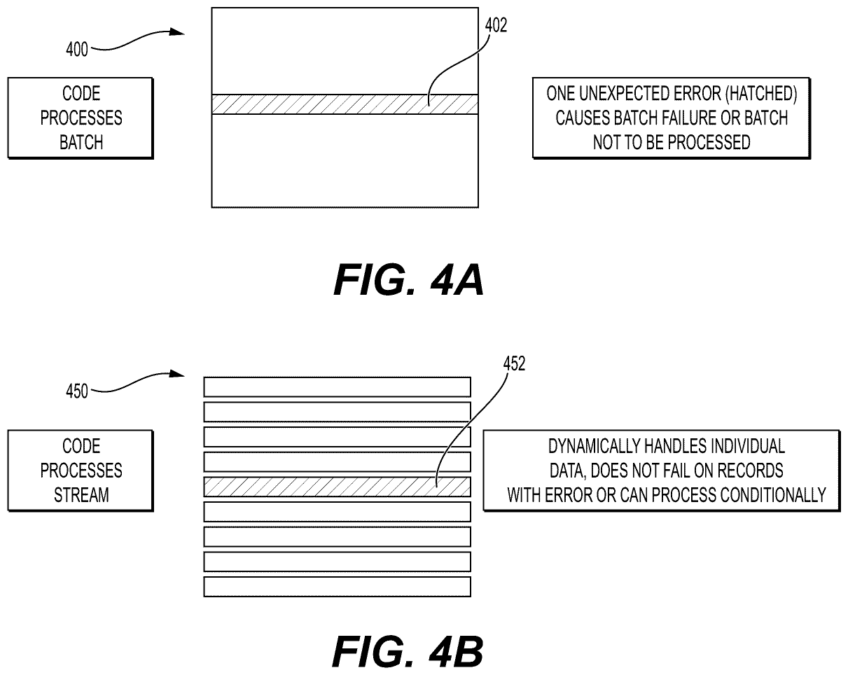

Further, batch processing may also lead to data integrity issues. If an error occurs during the processing of a batch, it can affect all data in that batch, leading to inaccurate results in downstream process. Additionally if the batch processing system is not properly monitored and maintained, it may lead to data quality problems such as missing or duplicate data. Batch processing may allow for handling of large data volumes, but the impact on downstream process and systems may lower the effectiveness of the system. Batch data processing may be dependent on rigid requirements of source data and output data. As depicted in FIG. 4A, a single piece of data in the entire batch with an error can cause the entire batch to be lost, and a crash in the program. Changing routing conditions at any step of the data pipeline process may have a high likelihood of causing at least one of the records in the batch to not behave as expected leading to said losses or crashes.

The techniques described herein may offer dynamic data processing that offer improvements over the process of FIG. 3A. By implementing stream processing, event data may be processed more efficiently.

FIG. 3B may depict an exemplary process flow chart for a data processing, according to one or more embodiments. The system described herein may streamline the batch data enrichment, export, and analysis stage all into one real time streaming process.

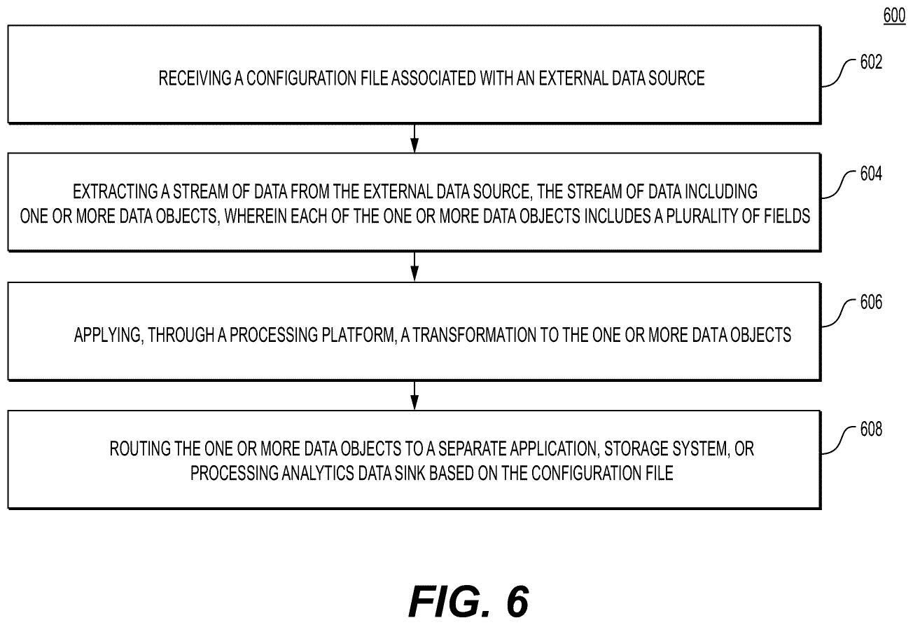

Step 310 may correspond to step 602 of FIG. 6 described below, where a stream of data may be received (e.g., by the ingestion module 192) from one or more data sources (e.g., data source 190). For example, the ingestion module 192 may receive a plurality of data objects from multiple data sources (e.g., data source 190). This may occur simultaneously or in short periods of time (e.g., within a few milliseconds).

At step 312, data may be processed, enriched, exported, and analyzed in real time utilizing the techniques described herein. The system described herein may for example utilize stream processing to overcome the challenges posed by batch processing in a data pipeline. The stream-processing techniques of the system described herein may implement a method that analyzes, filters, transforms, and enhances continuous data streams in real-time as they flow, then sends them to application, storage systems or other stream-processing analytics.

FIG. 4A may depict an exemplary flowchart 400 of an error causing batch failure, according to one or more embodiments. Flowchart 400 may depict how a conventional data pipeline may process an unexpected processing error 402. The conventional system may, upon receiving a single unexpected processing error 402, cause batch failure and the entire batch being processed by be effected. This may cause delays in an IT system.

FIG. 4B may depict an exemplary flowchart 450 of an error occurring within streamline processing, according to one or more embodiments. This may correspond to an error occurring when implementing the methods described herein. Flowchart 450 depicts the systems described herein that implements processing streaming to process received event data. As shown, when an exemplary error 452 occurs, the system may only fail with respect to the particular processing for that piece of data. As streamline processing may involve dynamically handling individual data, a single error may not affect the processing of other pieces of data.

FIG. 5 depicts a chart 500 of exemplary transformations in a configuration file, according to one or more embodiments. Configuration files may be created by an external system (e.g., on external servers or the computer system 700) and the new or updated configuration file may be received by the processing platform 194.

An exemplary configuration file may have a top level which is an indicator of a particular data source associated with the configuration file. In this example, the data source may be referred to as “change.” At a second level, the configuration file may further specify the types of data routing, which may be “key_1 speed” for speed processing and “key_2_batch” for batch processing. The second level may further include top level “fields,” and “new fields”, where fields specify the original incoming data fields. The code may dynamically transform the incoming data depending on the json configuration's specifications. Exemplary transformations of a configuration file may include specifying data route 502, general transformations 504, specific field transformations 506, and creation of new fields 508.

Specifying data route 502 may allow for a user to user can easily specify incoming data and route the data to specific places as is. Exemplary code for specifying data route 502 may be displayed below:

Example incoming data as: {″field1″: ″value1″}
Following configuration json file this data is mapped to ″key_1_speed″
with the original name ″field1″. User can specify the data’s routing.
Code end with it in speed_dict with : {″field1″: ″value1″}

General transformations 504 may allow users to easily rename data and chose general functions to apply to the fields of the data object. Exemplary code for General transformations 504 may be displayed below:

Example incoming data as: {″field2″: ″VALUE2″}
Following configuration json file this data is mapped to ″key_2_batch″
AND with a new name of ″field2_target″ AND with the function
″flink_to_lower″ applied to value ″VALUE2″
Code end with it in batch_dict with {″field2_target″: ″value2″}

Specific field transformations 506 may allow users to apply specific functions and unique data values to apply. For example, implementing the one or more machine learning algorithms within the processing platform 194 may be a specific field transformation 506. Exemplary code for specific field transformations 506 may be displayed below:

Example cmdb_ci comes in as {′cmdb_ci′: ′https://uniqueurl.sub-
dir.com/api/now/table/cmdb_ci/fa2e01b3cbd9000c3e0ea9f5624bcba1′}
Following configuration json file this data is mapped to ″key_2_batch″
with its original name of ″cmdb_ci″ and with the field specific function
″get_cmdb_ci″ it's value is changed from ′https://uniqueurl.sub-
dir.com/api/now/table/cmdb_ci/fa2e01b3cbd9000c3e0ea9f5624bcba1′
to ′fa2e01b3cbd9000c3e0ea9f5624bcba1′
Code ends in batch_dict as
{′cmdb_ci′: 'fa2e01b3cbd9000c3e0ea9f5624bcba1′}

Creating new fields 508 may allow a user to create new fields from specific or general functions. For example, a transformation (e.g., general or specific) may create values that are relevant to a data object. These may be relevant and need further processing. Exemplary code for creating new fields 508 may be displayed below:

In level 2 of the json configuration file we see ″new_fields″. The new field
″flink_ingest_timestamp_utc″ has specifications of belonging to
″key_2_batch″ and will get its value from the function
″add_flink_timestamp″ Batch_dict has the record added:
{ ′flink_ingest_timestamp_utc′: ′23-12-15 18:21:06.173536′}

An exemplary set of code for updating an exemplary configuration file may be shown below:

```
import json
with open(′config1.json′) as f:
  config_data = json.load(f)
import pytz
from datetime import datetime
data1 = {″field1″: ″value1″, ″field2″: ″VALUE2″,
    ′cmdb_ci′: ′https://uniqueurl.sub-
  dir.com/api/now/table/cmdb_ci/fa2e01b3cbd9000c3e0ea9f5624bcba1′}
class Change_functions:
  def__init__(self, json_data):
    self.data = json_data
def add_flink_timestamp(self, fieldname):
    self.data[fieldname] = datetime.now(pytz.utc).strftime(′%y-%m-%d
%H:%M:%S.%f′)
  def flink_to_lower(self, original_fieldname, target_fieldname):
    self.data[target_fieldname] = self.data[original_fieldname].lower( )
  def get_cmbd_ci(self, original_fieldname, target_fieldname):
self.data[target_fieldname] = self.data.pop(original_fieldname,None).
split(′/′)[−1] if original_fieldname in self.data else None
    return self.data
speed_dict = { }
batch_dict = { }
change_functions = Change_functions(data1)
for main_fields in config_data[′change′][′fields′].keys( ):
  if config_data[′change′][′fields′][main_fields][′stream_key′] ==
″key_1_speed″:
    if config_data[′change′][′fields′][main_fields][′function′]:
change_functions.__getattribute__(config_data[′change′][′fields′]
[′main_fields′][′function′])
(main_fields, config_data[′change′][′fields′][main_fields][′target_name′])
    speed_dict[config_data[′change′][′fields′][main_fields][′target_name′]] =
change_functions.data
[config_data[′change′][′fields′][main_fields][′target_name′]]
  if config_data[′change′][′fields′][main_fields][′stream_key′]==
′key_2_batch′:
    if config_data[′change′][′fields′][main_fields][′function′]:
change_functions.__getattribute__(config_data[′change′][′fields′]
[main_fields][′function′])
(main_fields, config_data[′change′][′fields′][main_fields][′target_name′])
    batch_dict[config_data[′change′][′fields′][main_fields][′target_name′]] =
change_functions.data[config_data[′change′][′fields′][main_fields]
[′target_name′]]
for new_field in config_data[′change′][′new_fields′].keys( ):
  if config_data[′change′][′new_fields′][new_field][′stream_key′] ==
″key_1_speed″:
change_functions.__getattribute__(config_data[′change′][′new_fields′]
[new_field][′function′])(new_field)
    speed_dict[new_field] = change_functions.data[new_field]
  if config_data[′change′][′new_fields′][new_field][′stream_key′] ==
″key_2_batch″:
change_functions.__getattribute__(config_data[′change′][′new_fields′]
[new_field][′function′])(new_field)
    batch_dict[new_field] = change_functions.data[new_field]
print(speed_dict)
print(batch_dict)
```

FIG. 6 depicts a flowchart of a process 600 for routing and processing real-time information event technology data, according to one or more embodiments. The process described in FIG. 6 may be implemented by the data pipeline system 100 of FIG. 1A and/or by the system 185 of FIG. 1B.

Step 602 may include receiving a configuration file associated with an external data source (e.g., data source 190). The configuration file may include commands for each set of fields of the one or more data objects. The configuration file may determine whether each field in the set of field has a particular transformation applied and which set of fields do not need a transformation applied before the routing of the one or more data objects.

Step 604 may include extracting a stream of data from the external data source, the stream of data including one or more data objects, wherein each of the one or more data objects includes a plurality of fields. This may further include ingesting (e.g., by the ingestion module 192) the one or more data objects, wherein ingesting the one or more data objects includes assigning a timestamp field and a field indicating the association of the external data source to each of the one or more data objects.

Step 606 may include applying, through a processing platform (e.g., processing platform 194), a transformation to the one or more data objects, wherein applying the transformation includes applying the transformation to a first field of the plurality of fields for each of the one or more data objects. This may take place within a tenth of a second of ingestion the one or more data objects.

The processing platform may include a local repository of an intelligence layer of a machine learning algorithm. Step 606 may further include applying a second transformation with the intelligence layer to a second field of the plurality of fields for each of the one or more data objects based on the configuration file. The processing platform may not interact with any outsider servers while applying the intelligence layer.

Applying the transformation to the one or more data objects may include reading the configuration file; based on settings of the configuration file, identifying whether to perform a respective transformation for each field of the plurality of fields for each of the one or more data objects; based on settings of the configuration file, determining what type of respective transformation to apply to the identified fields for each of the one or more data objects; and applying the determined respective transformation to each of the identified fields for each of the one or more data objects.

Step 608 may include routing the one or more data objects to a separate application, storage system, or processing analytics data sink (e.g., the application storage, or data sink 196) based on the configuration file.

The method may further include, upon routing the one or more data objects, applying a batch level processing to one or more fields of the plurality of fields for the one or more data object, wherein the one or more fields did not have a transformation applied by the processing platform.

As illustrated in FIG. 7, the computer system 700 may include a processor 702, e.g., a central processing unit (CPU), a graphics processing unit (GPU), or both. The processor 702 may be a component in a variety of systems. For example, the processor 702 may be part of a standard personal computer or a workstation. The processor 702 may be one or more general processors, digital signal processors, application specific integrated circuits, field programmable gate arrays, servers, networks, digital circuits, analog circuits, combinations thereof, or other now known or later developed devices for analyzing and processing data. The processor 702 may implement a software program, such as code generated manually (i.e., programmed).

The computer system 700 may include a memory 704 that can communicate via a bus 708. The memory 704 may be a main memory, a static memory, or a dynamic memory. The memory 704 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 704 includes a cache or random-access memory for the processor 702. In alternative implementations, the memory 704 is separate from the processor 702, such as a cache memory of a processor, the system memory, or other memory. The memory 704 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 704 is operable to store instructions executable by the processor 702. The functions, acts or tasks illustrated in the figures or described herein may be performed by the programmed processor 702 executing the instructions stored in the memory 704. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 700 may further include a display 710, such as a liquid crystal display (LCD), an organic light emitting diode (OLED), a flat panel display, a solid-state display, a cathode ray tube (CRT), a projector, a printer or other now known or later developed display device for outputting determined information. The display 710 may act as an interface for the user to see the functioning of the processor 702, or specifically as an interface with the software stored in the memory 704 or in a disk or optical drive unit 706 of the computer system 700.

Additionally or alternatively, the computer system 700 may include an input device 712 configured to allow a user to interact with any of the components of the computer system 700. The input device 712 may be a number pad, a keyboard, or a cursor control device, such as a mouse, or a joystick, touch screen display, remote control, or any other device operative to interact with the computer system 700.

The disk or optical drive unit 706 may include a computer-readable medium 722 in which one or more sets of instructions 724, e.g., software, can be embedded. Further, the instructions 724 may embody one or more of the methods or logic as described herein. The instructions 724 may reside completely or partially within the memory 704 and/or within the processor 702 during execution by the computer system 700. The memory 704 and the processor 702 also may include computer-readable media as discussed above.

In some systems, a computer-readable medium 722 includes instructions 724 or receives and executes instructions 724 responsive to a propagated signal so that a device connected to a network 770 can communicate voice, video, audio, images, or any other data over the network 770. Further, the instructions 724 may be transmitted or received over the network 770 via a communication port or interface 720, and/or using a bus 708. The communication port or interface 720 may be a part of the processor 702 or may be a separate component. The communication port or interface 720 may be created in software or may be a physical connection in hardware. The communication port or interface 720 may be configured to connect with a network 770, external media, the display 710, or any other components in the computer system 700, or combinations thereof. The connection with the network 770 may be a physical connection, such as a wired Ethernet connection or may be established wirelessly as discussed below. Likewise, the additional connections with other components of the computer system 700 may be physical connections or may be established wirelessly. The network 770 may alternatively be directly connected to the bus 708.

While the computer-readable medium 722 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 722 may be non-transitory, and may be tangible.

The computer-readable medium 722 can include a solid-state memory such as a memory card or other package that houses one or more non-volatile read-only memories. The computer-readable medium 722 can be a random-access memory or other volatile re-writable memory. Additionally or alternatively, the computer-readable medium 722 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 700 may be connected to one or more networks 770. The network 770 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 770 may include wide area networks (WAN), such as the Internet, local area networks (LAN), campus area networks, metropolitan area networks, a direct connection such as through a Universal Serial Bus (USB) port, or any other networks that may allow for data communication. The network 770 may be configured to couple one computing device to another computing device to enable communication of data between the devices. The network 770 may generally be enabled to employ any form of machine-readable media for communicating information from one device to another. The network 770 may include communication methods by which information may travel between computing devices. The network 770 may be divided into sub-networks. The sub-networks may allow access to all of the other components connected thereto or the sub-networks may restrict access between the components. The network 770 may be regarded as a public or private network connection and may include, for example, a virtual private network or an encryption or other security mechanism employed over the public Internet, or the like.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein. Although the present specification describes components and functions that may be implemented in particular implementations with reference to particular standards and protocols, the disclosure is not limited to such standards and protocols.

For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A method for routing and processing real-time information event technology data, the method comprising:
receiving a configuration file associated with an external data source;
extracting a stream of data from the external data source, the stream of data including one or more data objects, wherein each of the one or more data objects includes a plurality of fields;
applying, through a processing platform, a transformation to the one or more data objects, wherein applying the transformation includes applying the transformation to a first field of the plurality of fields for each of the one or more data objects; and
routing the one or more data objects to a separate application, storage system, or processing analytics data sink based on the configuration file.

2. The method of claim 1, wherein the configuration file includes commands for each of the plurality of fields of the one or more data objects, wherein each of the plurality of fields corresponds to a particular piece of metadata associated with the one or more data objects.

3. The method of claim 1, wherein the configuration file determines whether each field in the plurality of fields has a particular transformation applied and which of the plurality of fields do not need a transformation applied before the routing of the one or more data objects.

4. The method of claim 1, further including:
ingesting the one or more data objects, wherein ingesting the one or more data objects includes assigning a timestamp field and a field indicating the association of the external data source to each of the one or more data objects.

5. The method of claim 4, wherein the applying the transformation to the one or more data objects takes place within a tenth of a second of ingesting the one or more data objects.

6. The method of claim 1, wherein the processing platform includes a local repository of an intelligence layer of a machine learning algorithm, the method further including:
applying a second transformation with the intelligence layer to a second field of the plurality of fields for each of the one or more data objects based on the configuration file.

7. The method of claim 6, wherein the processing platform does not interact with any outsider servers while applying the intelligence layer.

8. The method of claim 1, wherein, the applying the transformation to the one or more data objects includes:
reading the configuration file;
based on settings of the configuration file, identifying whether to perform a respective transformation for each field of the plurality of fields for each of the one or more data objects;
based on settings of the configuration file, determining what type of respective transformation to apply to the identified fields for each of the one or more data objects; and
applying the determined respective transformation to each of the identified fields for each of the one or more data objects.

9. The method of claim 1, further including:
upon routing the one or more data objects, applying a batch level processing to one or more fields of the plurality of fields for the one or more data object, wherein the one or more fields did not have a transformation applied by the processing platform.

10. A system for routing and processing real-time information event technology data, the system comprising:
a memory having processor-readable instructions stored therein; and
at least one processor configured to access the memory and execute the processor-readable instructions to perform operations including:
receiving a configuration file associated with an external data source;
extracting a stream of data from the external data source, the stream of data including one or more data objects, wherein each of the one or more data objects includes a plurality of fields;
applying, through a processing platform, a transformation to the one or more data objects, wherein applying the transformation includes applying the transformation to a first field of the plurality of fields for each of the one or more data objects; and
routing the one or more data objects to a separate application, storage system, or processing analytics data sink based on the configuration file.

11. The system of claim 10, wherein the configuration file includes commands for each of the plurality of fields of the one or more data objects, wherein each of the plurality of fields corresponds to a particular piece of metadata associated with the one or more data objects.

12. The system of claim 10, wherein the configuration file determines whether each field in the plurality of fields has a particular transformation applied and which fields of the plurality of fields do not need a transformation applied before the routing of the one or more data objects.

13. The system of claim 10, further including:
ingesting the one or more data objects, wherein ingesting the one or more data objects includes assigning a timestamp field and a field indicating the association of the external data source to each of the one or more data objects.

14. The system of claim 13, wherein the applying the transformation to the one or more data objects takes place within a tenth of a second of ingesting the one or more data objects.

15. The system of claim 10, wherein the processing platform includes a local repository of an intelligence layer of a machine learning algorithm, the system further including:
applying a second transformation with the intelligence layer to a second field of the plurality of fields for each of the one or more data objects based on the configuration file.

16. The system of claim 10, wherein, the applying the transformation to the one or more data objects includes:
reading the configuration file;
based on settings of the configuration file, identifying whether to perform a respective transformation for each field of the plurality of fields for each of the one or more data objects;
based on settings of the configuration file, determining what type of respective transformation to apply to the identified fields for each of the one or more data objects; and
applying the determined respective transformation to each of the identified fields for each of the one or more data objects.

17. The system of claim 10, further including:
upon routing the one or more data objects, applying a batch level processing to one or more fields of the plurality of fields for the one or more data object, wherein the one or more fields did not have a transformation applied by the processing platform.

18. A non-transitory computer readable medium configured to store processor-readable instructions which, when executed by at least one processor, cause the at least one processor to perform operations including:
receiving a configuration file associated with an external data source;
extracting a stream of data from the external data source, the stream of data including one or more data objects, wherein each of the one or more data objects includes a plurality of fields;
applying, through a processing platform, a transformation to the one or more data objects, wherein applying the transformation includes applying the transformation to a first field of the plurality of fields for each of the one or more data objects; and
routing the one or more data objects to a separate application, storage system, or processing analytics data sink based on the configuration file.

19. The non-transitory computer readable medium of claim 18, wherein the processing platform includes a local repository of an intelligence layer of a machine learning algorithm, further includes:
applying a second transformation with the intelligence layer to a second field of the plurality of fields for each of the one or more data objects based on the configuration file.

20. The non-transitory computer readable medium of claim 18, wherein, the applying the transformation to the one or more data objects includes:
reading the configuration file;
based on settings of the configuration file, identifying whether to perform a respective transformation for each field of the plurality of fields for each of the one or more data objects;
based on settings of the configuration file, determining what type of respective transformation to apply to the identified fields for each of the one or more data objects; and
applying the determined respective transformation to each of the identified fields for each of the one or more data objects.
